(19) United States
(12) Patent Application Publication
(10) Pub. No.: US 2021/0349361 A1
(43) Pub. Date: Nov. 11, 2021

(54) PIXEL STRUCTURE AND LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventors: Kunhuang PENG, Shenzhen, Guangdong (CN); Wu CAO, Shenzhen, Guangdong (CN); Yun YU, Shenzhen, Guangdong (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 17/047,480

(22) PCT Filed: Jul. 3, 2020
(86) PCT No.: PCT/CN2020/100153

§ 371 Date: Oct. 14, 2020

(30) Foreign Application Priority Data
May 8, 2020 (CN) 202010380047.0

(51) Int. Cl. G02F 1/1362; G02F 1/1343; G02F 1/1368

(52) U.S. Cl. CPC G02F 1/136209; G02F 1/136286; G02F 1/134309; G02F 1/1368; G02F 2201/121; G02F 1/13624; G02F 1/13439; G02F 2201/123; G02F 1/136222

(57) ABSTRACT

A pixel structure and a liquid crystal display panel are provided. In the present disclosure, a pixel area includes a pixel electrode connected to scan lines and data lines by thin film transistor (TFT) components, a light-shielding matrix disposed between adjacent ones of pixel areas, and a common electrode line disposed along at least outer edges of the pixel electrode and having a frame-shaped electrode, wherein a side of the common electrode line adjacent to the light-shielding matrix is disposed as a concave part, and an inner corner of the concave part is covered by the light-shielding matrix in a direction of a thickness of the pixel structure, reducing light leakage of the pixel structure in a dark state.

### TECHNICAL FIELD

The present disclosure relates to the field of manufacturing technology of display panels, and in particular, to a pixel structure and a liquid crystal display panel.

### BACKGROUND

With increasing demand for screen contrast of high-quality liquid crystal display panels, a contrast level of a liquid crystal display is to a great extent determined by brightness in a dark state. Contrast of a product can be greatly improved by reducing light leakage in the dark state.

An array substrate is usually arranged to cooperate with a color filter substrate. The array substrate comprises metal lines, which may cause light leakage due to a manufacturing process and an arrangement structure thereof. For incident horizontally polarized light, corners or edges of the metal lines in non-horizontal and non-vertical directions will affect its polarization in particular, leading to a phenomenon similar to diffraction and a partial change of polarization direction at the same time, which result in the light leakage during a dark-state picture. As shown in FIG. 1, an array substrate in the prior art comprises data lines 1011 and 1012, common electrode lines 1021 and 1022, and a black matrix 103. The black matrix 103 does not completely cover the common electrode lines 1021 and 1022, and portions exposed outside the black matrix 103 lead to a serious light leakage, which affects display quality of a liquid crystal display panel.

Therefore, it is necessary to design a new structure to solve a technical problem of light leakage caused by a certain deflection of a polarization direction of partial transmissive light at the corners of the metal lines of the liquid crystal display panel in the prior art.

### SUMMARY

Embodiments of the present disclosure provide a pixel structure and a liquid crystal display panel, which can solve the technical problem of the light leakage caused by the certain deflection of the polarization direction of the partial transmissive light at the corners of the metal lines of the liquid crystal display panel in the prior art.

To solve the above problem, technical solutions provided in the present disclosure are as follows: a pixel structure provided in an embodiment of the present disclosure comprising at least two scan lines and at least two data lines which are disposed interlaced to define pixel areas, wherein at least one of the pixel areas comprises a pixel electrode connected to the scan lines and the data lines by thin film transistor (TFT) components, a light-shielding matrix disposed between adjacent ones of the pixel areas, and a common electrode line disposed along at least outer edges of the pixel electrode and having a frame-shaped electrode, and wherein a side of the common electrode line adjacent to the light-shielding matrix is disposed as a concave part, and an inner corner of the concave part is covered by the light-shielding matrix in a direction of a thickness of the pixel structure.

According to a preferable embodiment of the present disclosure, an outer corner of the concave part is disposed outside a covering area of the light-shielding matrix.

According to a preferable embodiment of the present disclosure, any edge of the concave part in the outer corner parallel to the light-shielding matrix is disposed outside the covering area of the light-shielding matrix, and the other part is disposed within the covering area of the light-shielding matrix.

According to a preferable embodiment of the present disclosure, an angle of the inner corner of the concave part ranges from 90° to 180°, and an angle of the outer corner of the concave part ranges from 0° to 90°.

According to a preferable embodiment of the present disclosure, a section shape of the concave part is rectangular, wave-shaped, or sawtooth-shaped, and a vertical height of the concave part ranges from 3 μm to 20 μm.

According to a preferable embodiment of the present disclosure, at least one of the pixel areas further comprises a main pixel portion and a sub-pixel portion, wherein the main pixel portion comprises a first TFT and a first pixel electrode, the first TFT comprises a first gate electrode, a first source electrode, and a first drain electrode, the first gate electrode is connected to the scan lines, the first source electrode is connected to the data lines, and the first drain electrode is connected to the first pixel electrode, and wherein the sub-pixel portion comprises a second TFT and a second pixel electrode, the second TFT comprises a second gate electrode, a second source electrode, and a second drain electrode, the second gate electrode is connected to the scan lines, the second source electrode is connected to the data lines, and the second drain electrode is connected to the second pixel electrode.

According to a preferable embodiment of the present disclosure, the sub-pixel portion further comprises a share TFT, wherein the share TFT comprises a third gate electrode, a third source electrode, and a third drain electrode, the third gate electrode is connected to the scan lines, the third source electrode is connected to the second drain electrode, and the third drain electrode is connected to a share electrode line of the pixel structure, and wherein the share TFT is configured to adjust brightness of the sub-pixel portion so that brightness of the main pixel portion is the same as that of the sub-pixel portion.

According to a preferable embodiment of the present disclosure, the share electrode line is disposed on the common electrode line, and materials of the share electrode line and the common electrode lines comprise indium tin oxide or indium zinc oxide.

According to the above pixel structure, an embodiment of the present disclosure provides a liquid crystal display panel comprising an array substrate, a color filter substrate disposed opposite to the array substrate, and a liquid crystal layer disposed between the array substrate and the color filter substrate, wherein the array substrate comprises a pixel structure, and the pixel structure comprises at least two scan lines and at least two data lines which are disposed interlaced to define pixel areas, wherein at least one of the pixel areas comprises a pixel electrode connected to the scan lines and the data lines by thin film transistor (TFT) components, a light-shielding matrix disposed between adjacent ones of the pixel areas, and a common electrode line disposed along at least outer edges of the pixel electrode and having a frame-shaped electrode, and wherein a side of the common electrode line adjacent to the light-shielding matrix is disposed as a concave part, an inner corner of the concave part is covered by the light-shielding matrix in a direction of a thickness of the pixel structure, and an outer corner of the concave part is disposed outside a covering area of the light-shielding matrix.

According to a preferable embodiment of the present disclosure, any edge of the concave part in the outer corner parallel to the light-shielding matrix is disposed outside the covering area of the light-shielding matrix, and the other part is disposed within the covering area of the light-shielding matrix.

According to a preferable embodiment of the present disclosure, an angle of the inner corner of the concave part ranges from 90° to 180°, and an angle of the outer corner of the concave part ranges from 0° to 90°.

According to a preferable embodiment of the present disclosure, a section shape of the concave part is rectangular, wave-shaped, or sawtooth-shaped, and a vertical height of the concave part ranges from 3 μm to 20 μm.

According to a preferable embodiment of the present disclosure, a color resist layer is disposed between layers of the pixel electrode and the common electrode line.

According to a preferable embodiment of the present disclosure, at least one of the pixel areas comprises a main pixel portion and a sub-pixel portion, wherein the main pixel portion comprises a first TFT and a first pixel electrode, the first TFT comprises a first gate electrode, a first source electrode, and a first drain electrode, the first gate electrode is connected to the scan lines, the first source electrode is connected to the data lines, and the first drain electrode is connected to the first pixel electrode; and wherein the sub-pixel portion comprises a second TFT and a second pixel electrode, the second TFT comprises a second gate electrode, a second source electrode, and a second drain electrode, the second gate electrode is connected to the scan lines, the second source electrode is connected to the data lines, and the second drain electrode is connected to the second pixel electrode.

According to a preferable embodiment of the present disclosure, the sub-pixel portion further comprises a share TFT, wherein the share TFT comprises a third gate electrode, a third source electrode, and a third drain electrode, the third gate electrode is connected to the scan lines, the third source electrode is connected to the second drain electrode, and the third drain electrode is connected to a share electrode line of the pixel structure, and wherein the share TFT is configured to adjust brightness of the sub-pixel portion so that brightness of the main pixel portion is the same as that of the sub-pixel portion.

According to a preferable embodiment of the present disclosure, the share electrode line is disposed on the common electrode line, and materials of the share electrode line and the common electrode line comprise indium tin oxide or indium zinc oxide.

According to a preferable embodiment of the present disclosure, widths of the share electrode line and the common electrode line are equal to or less than 10 μm.

According to a preferable embodiment of the present disclosure, the color resist layer comprises red color resist blocks, green color resist blocks, and blue color resist blocks which are disposed at intervals, and a black matrix is disposed in gaps among the red color resist blocks, the green color resist blocks, and the blue color resist blocks.

According to a preferable embodiment of the present disclosure, a common electrode layer is disposed on a surface of the color filter substrate, and the common electrode layer is disposed over the pixel areas.

The embodiments of the present disclosure provide the pixel structure and the liquid crystal display panel. The pixel structure in the present disclosure comprises the at least two scan lines and at least two data lines which are disposed interlaced to define pixel areas, wherein at least one of the pixel areas comprises a pixel electrode connected to the scan lines and the data lines by thin film transistor (TFT) components, a light-shielding matrix disposed between adjacent ones of the pixel areas, and a common electrode line disposed along at least outer edges of the pixel electrode and having a frame-shaped electrode, and wherein a side of the common electrode line adjacent to the light-shielding matrix is disposed as a concave part, and an inner corner of the concave part is covered by the light-shielding matrix in a direction of a thickness of the pixel structure. Thus, on the premise of not changing a width of the common electrode line, distances between the exposed part of the common electrode line and the edges of the black matrix are disposed to be same, which does not affect an aperture ratio rate of pixels. The inner corner of the concave part is totally covered by the black matrix, and an outer corner of the concave part is exposed, which can reduce the light leakage of the pixel structure in the dark state and improve the display quality of the liquid crystal display panel in case of a same inclination angle of the common electrode line.

### BRIEF DESCRIPTION OF DRAWINGS

To describe the technical solutions of the embodiments of the present disclosure or prior art more clearly, the following briefly introduces the accompanying drawings used in the description of the embodiments of the present disclosure or prior art. Apparently, the accompanying drawings described below illustrate only some exemplary embodiments of the present disclosure, and persons skilled in the art may derive other drawings from the drawings without making creative efforts.

FIG. 1 is a structural schematic diagram illustrating common electrode lines in the prior art.

FIG. 2 is a structural schematic diagram illustrating a pixel structure provided in an embodiment of the present disclosure.

FIG. 3 is a structural schematic diagram illustrating the other pixel structure provided in an embodiment of the present disclosure.

FIG. 4 is a schematic diagram illustrating a pixel driving circuit provided in an embodiment of the present disclosure.

FIG. 5 is a structural schematic diagram illustrating layers of a liquid crystal display panel provided in an embodiment of the present disclosure.

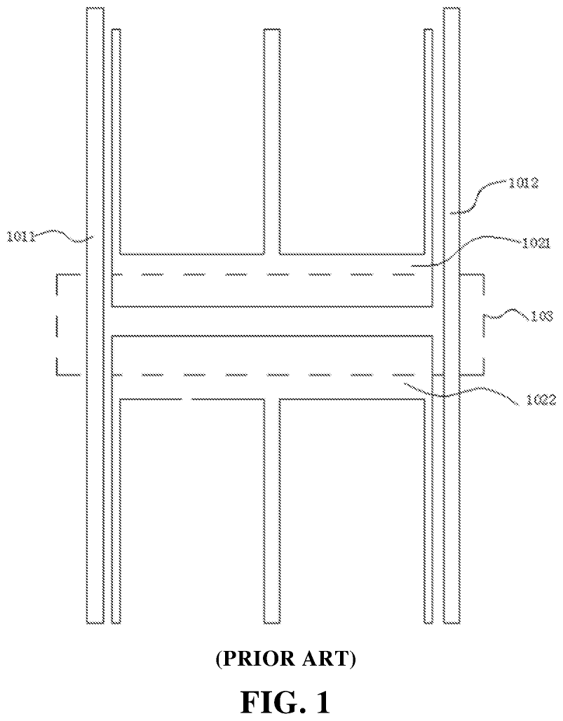

### DETAILED DESCRIPTION OF PREFERRED EMBODIMENTS

The following description of every embodiment with reference to the accompanying drawings is used to exemplify a specific embodiment which may be carried out in the present disclosure. Directional terms mentioned in the present disclosure, such as “top”, “bottom”, “front”, “back”, “left”, “right”, “inside”, “outside”, “side” etc., are only used with reference to orientations of the accompanying drawings. Therefore, the used directional terms are intended to illustrate, but not to limit, the present disclosure. In the accompanying drawings, units with similar structures are indicated by a same number, and dotted lines in the drawings refer to things that do not exist in the structure, which only illustrate a shape and a position of the structure.

The present disclosure is aimed at the technical problem of the light leakage caused by the deflection of the polarization direction of the partial transmissive light at the corners of the metal lines of the liquid crystal display panel in the prior art. These embodiments can solve the defect.

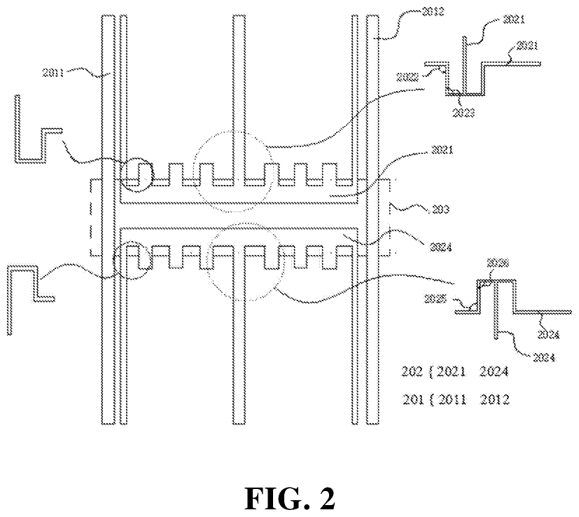

As shown in FIG. 2, an embodiment of the present disclosure provides a pixel structure comprising at least two scan lines and at least two data lines, such as data lines 201 comprising a data line 2011 and a data line 2012, and the scan lines and the data lines are disposed interlaced to define pixel areas. At least one of the pixel areas comprises a pixel electrode connected to the scan lines and the data lines by TFT components, a light-shielding matrix 203 disposed between adjacent ones of the pixel areas, and a common electrode line 202 disposed along at least outer edges of the pixel electrode and having a frame-shaped electrode, wherein a side of the common electrode line 202 adjacent to the light-shielding matrix 203 is disposed as a concave part, and an inner corner of the concave part is covered by the light-shielding matrix 203 in a direction of a thickness of the pixel structure.

A light leakage may occur due to a manufacturing process and an arrangement structure of the common electrode line. For incident horizontally polarized light, corners or edges of the common electrode line in non-horizontal and non-vertical directions will affect its polarization in particular, leading to a phenomenon similar to diffraction and a partial change of the polarization direction at the same time, which result in the light leakage of the pixel structure during a dark picture. In the embodiment of the present disclosure, the common electrode line is disposed along outer edges of the pixel electrode and has a frame-shaped electrode, a side of the common electrode line adjacent to the light-shielding matrix is disposed as a concave part, and an inner corner of the concave part is covered by the light-shielding matrix 203 in a direction of a thickness of the pixel structure. In addition, a horizontal electric field is formed between the concave part and the pixel electrode, which affects liquid crystals near the common electrode line to deflect to a preset position to prevent the light leakage of the pixel structure during the dark-state picture. In the embodiment, the common electrode line 202 comprises a first common electrode line 2021 and a second common electrode line 2024 disposed at opposite sides of the scan line. A side of each of the first common electrode line 2021 and the second common electrode line 2024 away from the light-shielding matrix 203 comprises a concave part, wherein a section shape of the concave part is rectangular, wave-shaped, or sawtooth-shaped, a vertical height of the concave part ranges from 3 μm to 20 μm, and an inner corner of the concave part is covered by the light-shielding matrix 203. An outer corner of the concave part is disposed outside a covering area of the light-shielding matrix 203, any edge of the concave part in the outer corner parallel to the light-shielding matrix 203 is disposed outside the covering area of the light-shielding matrix, and the other part is disposed within the covering area of the light-shielding matrix 203. An angle of the outer corner of the concave part ranges from 0° to 90°, and an angle of the inner corner of the concave part ranges from 90° to 180°. For example, a concave part of an edge of the first common electrode line 2021 edge and a concave part of an edge of the second common electrode line 2024 are symmetric with respect to a center line of the light-shielding matrix 203, angles of inner corners 2023 and 2026 range from 90° to 180°, and angles of outer corners 2022 and 2025 range from 0° to 90°. In the embodiment, a color resist layer is disposed between layers of the pixel electrode and the common electrode line 202.

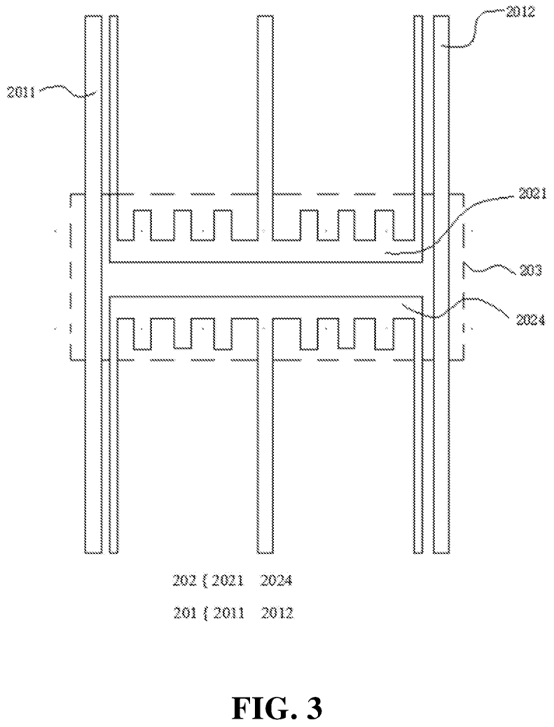

As shown in FIG. 3, the light-shielding matrix 203 completely covers the concave parts of the first common electrode line 2021 and the second common electrode line 2024, and the other structure is similar to that in FIG. 2, which is not described for further details.

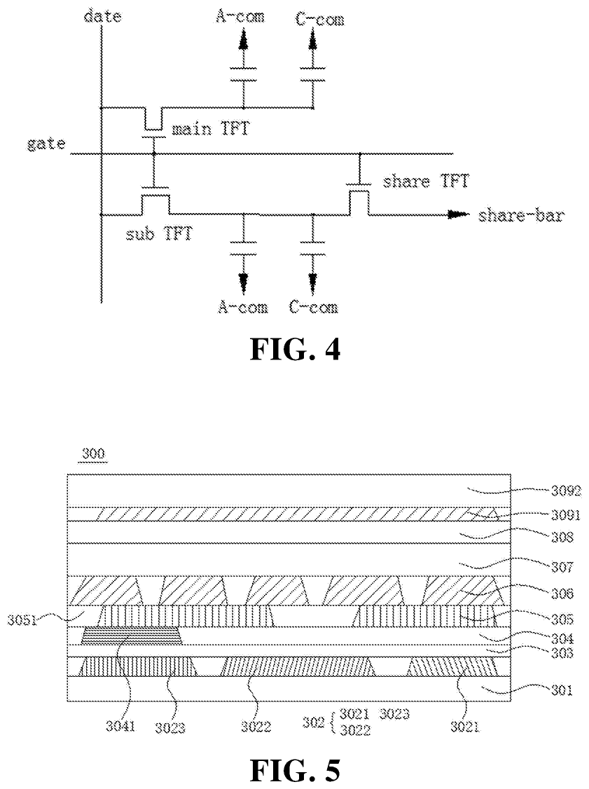

As shown in FIG. 4, an embodiment of the present disclosure provides a pixel driving circuit. The pixel driving circuit in the embodiment comprises storage capacitors, liquid crystal capacitors, scan lines, data lines, a first common electrode line, a second common electrode line, a common electrode, a first TFT, a second TFT, and a share TFT, wherein in the embodiment, the first TFT corresponds to a main TFT in FIG. 4, the second TFT corresponds to a sub TFT in FIG. 4, and the share TFT corresponds to a share TFT in FIG. 4. The scan lines and the data lines are disposed interlaced to define pixel areas, wherein at least one of the pixel areas comprises a main pixel portion and a sub-pixel portion, and the main pixel portion and the sub-pixel portion comprises a first pixel electrode and a second pixel electrode respectively. The main pixel portion comprises a first TFT and the first pixel electrode, and the first TFT comprises a first gate electrode, a first source electrode, and a first drain electrode, wherein the first gate electrode is connected to the scan lines, the first source electrode is connected to the data lines, the first drain electrode is electrically connected to the first pixel electrode, the first pixel electrode is electrically connected to one of the storage capacitors and one of the liquid crystal capacitors, the other end of the storage capacitor is connected to a first common electrode line A-com, and the other end of the liquid crystal capacitor is connected to a common electrode C-com. The sub-pixel portion comprises a second TFT and the second pixel electrode, and the second TFT comprises a second gate electrode, a second source electrode, and a second drain electrode, wherein the second gate electrode is connected to the scan lines, the second source electrode is connected to the data lines, the second drain electrode is connected to the second pixel electrode, the second pixel electrode is electrically connected to the other one of the storage capacitors and the other one of the liquid crystal capacitors, the other end of the storage capacitor is connected to a second common electrode line A-com, and the other end of the liquid crystal capacitor is connected to a common electrode C-com. The sub-pixel portion in the embodiment further comprises a share TFT, and the share TFT comprises a third gate electrode, a third source electrode, and a third drain electrode, wherein the third gate electrode is connected to the scan lines, the third source electrode is connected to the second drain electrode, and the third drain electrode is connected to a share electrode line (share-bar) of the pixel structure. The share electrode line is disposed over the common electrode line, and materials of the share electrode line and the common electrode line comprise indium tin oxide or indium zinc oxide. The share TFT is configured to adjust brightness of the sub-pixel portion so that brightness of the main pixel portion is the same as that of the sub-pixel portion, improving the display quality of the pixel structure.

According to the above pixel structure, an embodiment of the present disclosure provides a liquid crystal display panel 300 comprising the above pixel structure. In detail, as shown in FIG. 5, the liquid crystal display panel 300 comprises an array substrate, a color filter substrate disposed opposite to the array substrate, and a liquid crystal layer 307 disposed between the array substrate and the color filter substrate. The array substrate comprises a first substrate 301, a first metal layer 302 disposed on a surface of the first substrate 301, an insulation layer 303 disposed on a surface of the first metal layer 302, a second metal layer 304 disposed on a surface of the insulation layer 303, a color resist layer 305 disposed on a surface of the second metal layer 304, and a pixel electrode 306 disposed on a surface of the color resist layer 305. The first metal layer 302 comprises a scan line 3022, and a first common electrode line 3021 and a second common electrode line 3023 disposed at opposite sides of the scan line 3022, the second metal layer 304 comprises a share electrode line 3041, the color resist layer 305 comprises red color resists, green color resists, and blue color resists, and a black matrix 3051 is disposed among the red color resists, the green color resists, and the blue color resists. The liquid crystal layer 307 comprises a sealant, liquid crystals, and spacers. The sealant allows glass disposed at opposite sides of the liquid crystals to stick tightly. The liquid crystals are typically elliptical and connected along a long axis direction, each column of the liquid crystals is a liquid crystal domain, any adjacent two liquid crystal domains are independent from each other, boundaries between any adjacent two liquid crystal domains are continuously changing areas, and a deflection angle of the liquid crystals is determined by an electric field between a common electrode layer and a pixel electrode layer disposed at opposite sides of the liquid crystal layer. The color filter substrate is disposed on a surface of the liquid crystal layer, and comprises a second substrate 3092, a light-shielding matrix 3091 manufactured on a surface of the second substrate 3092, and a common electrode layer 308 manufactured on a surface of the light-shielding matrix 3091. The common electrode layer 308 is preferably disposed over the pixel area, the common electrode layer 308 is usually a transparent conductive film comprising indium tin oxide, and a width thereof usually ranges from 20 nm to 40 nm. In the embodiment, the common electrode layer 308 and the pixel electrode 306 are manufactured by a sputtering method, and material used comprises indium tin oxide or indium zinc oxide.

In the embodiment of the present disclosure, the first common electrode line 3021 and the second common electrode line 3023 generate horizontal electric fields with the pixel electrode 306 respectively. The horizontal electric fields make liquid crystals near the first common electrode line 3021 and the second common electrode line 3023 to deflect to a preset angle to reduce the light leakage of the liquid crystal display panel 300 in the dark state, improving the display quality of the liquid crystal display panel.

Embodiments of the present disclosure provide a pixel structure and a liquid crystal display panel. The pixel structure in the present disclosure comprises the at least two scan lines and at least two data lines which are disposed interlaced to define pixel areas, wherein at least one of the pixel areas comprises a pixel electrode connected to the scan lines and the data lines by TFT components, a light-shielding matrix disposed between adjacent ones of the pixel areas, and a common electrode line disposed along at least outer edges of the pixel electrode and having a frame-shaped electrode, and wherein a side of the common electrode line adjacent to the light-shielding matrix is disposed as a concave part, and an inner corner of the concave part is covered by the light-shielding matrix in a direction of a thickness of the pixel structure. Thus, on the premise of not changing a width of the common electrode line, distances between the exposed part of the common electrode line and the edges of the black matrix are disposed to be same, which does not affect an aperture ratio rate of pixels. The inner corner of the concave part is totally covered by the black matrix, and an outer corner of the concave part is exposed, which can reduce the light leakage in the dark state of the pixel structure and improve the display quality of the liquid crystal display panel in case of a same inclination angle of the common electrode line.

Although the present disclosure has been disclosed in the above preferred embodiments, the above preferred embodiments do not intend to limit the present disclosure. Various modifications and changes may be made by ordinary person skilled in the art without departing from the spirit and scope of this disclosure. Therefore, the scope of protection of this application is subject to the scope defined by the claims.

What is claimed is:

1. A pixel structure, comprising:
at least two scan lines and at least two data lines which are disposed interlaced to define pixel areas, wherein at least one of the pixel areas comprises:
a pixel electrode connected to the scan lines and the data lines by thin film transistor (TFT) components;
a light-shielding matrix disposed between adjacent ones of the pixel areas; and
a common electrode line disposed along at least outer edges of the pixel electrode and having a frame-shaped electrode;
wherein a side of the common electrode line adjacent to the light-shielding matrix is disposed as a concave part, and an inner corner of the concave part is covered by the light-shielding matrix in a direction of a thickness of the pixel structure.

2. The pixel structure as claimed in claim 1, wherein an outer corner of the concave part is disposed outside a covering area of the light-shielding matrix.

3. The pixel structure as claimed in claim 2, wherein any edge of the concave part in the outer corner parallel to the light-shielding matrix is disposed outside the covering area of the light-shielding matrix, and the other part is disposed within the covering area of the light-shielding matrix.

4. The pixel structure as claimed in claim 2, wherein an angle of the inner corner of the concave part ranges from 90° to 180°, and an angle of the outer corner of the concave part ranges from 0° to 90°.

5. The pixel structure as claimed in claim 1, wherein a section shape of the concave part is rectangular, wave-shaped, or sawtooth-shaped, and a vertical height of the concave part ranges from 3 μm to 20 μm.

6. The pixel structure as claimed in claim 1, wherein a color resist layer is disposed between layers of the pixel electrode and the common electrode line.

7. The pixel structure as claimed in claim 1, wherein at least one of the pixel areas further comprises a main pixel portion and a sub-pixel portion, wherein the main pixel portion comprises a first TFT and a first pixel electrode, the first TFT comprises a first gate electrode, a first source electrode, and a first drain electrode, the first gate electrode is connected to the scan lines, the first source electrode is connected to the data lines, and the first drain electrode is connected to the first pixel electrode; and
wherein the sub-pixel portion comprises a second TFT and a second pixel electrode, the second TFT comprises a second gate electrode, a second source electrode, and a second drain electrode, the second gate electrode is connected to the scan lines, the second source electrode is connected to the data lines, and the second drain electrode is connected to the second pixel electrode.

8. The pixel structure as claimed in claim 7, wherein the sub-pixel portion further comprises a share TFT, wherein the share TFT comprises a third gate electrode, a third source electrode, and a third drain electrode, the third gate electrode is connected to the scan lines, the third source electrode is connected to the second drain electrode, and the third drain electrode is connected to a share electrode line of the pixel structure; and
wherein the share TFT is configured to adjust brightness of the sub-pixel portion so that brightness of the main pixel portion is same as that of the sub-pixel portion.

9. The pixel structure as claimed in claim 8, wherein the share electrode line is disposed on the common electrode line, and materials of the share electrode line and the common electrode line comprise indium tin oxide or indium zinc oxide.

10. A liquid crystal display panel, comprising an array substrate, a color filter substrate disposed opposite to the array substrate, and a liquid crystal layer disposed between the array substrate and the color filter substrate, the array substrate comprising a pixel structure, and the pixel structure comprising:
at least two scan lines and at least two data lines which are disposed interlaced to define pixel areas, wherein at least one of the pixel areas comprises:
a pixel electrode connected to the scan lines and the data lines by thin film transistor (TFT) components;
a light-shielding matrix disposed between adjacent ones of the pixel areas; and
a common electrode line disposed along at least outer edges of the pixel electrode and having a frame-shaped electrode;
wherein a side of the common electrode line adjacent to the light-shielding matrix is disposed as a concave part, an inner corner of the concave part is covered by the light-shielding matrix in a direction of a thickness of the pixel structure, and an outer corner of the concave part is disposed outside a covering area of the light-shielding matrix.

11. The liquid crystal display panel as claimed in claim 10, wherein any edge of the concave part in the outer corner parallel to the light-shielding matrix is disposed outside the covering area of the light-shielding matrix, and the other part is disposed within the covering area of the light-shielding matrix.

12. The liquid crystal display panel as claimed in claim 10, wherein an angle of the inner corner of the concave part ranges from 90° to 180°, and an angle of the outer corner of the concave part ranges from 0° to 90°.

13. The liquid crystal display panel as claimed in claim 10, wherein a section shape of the concave part is rectangular, wave-shaped, or sawtooth-shaped, and a vertical height of the concave part ranges from 3 μm to 20 μm.

14. The liquid crystal display panel as claimed in claim 10, wherein a color resist layer is disposed between layers of the pixel electrode and the common electrode line.

15. The liquid crystal display panel as claimed in claim 10, wherein at least one of the pixel areas further comprises a main pixel portion and a sub-pixel portion, wherein the main pixel portion comprises a first TFT and a first pixel electrode, the first TFT comprises a first gate electrode, a first source electrode, and a first drain electrode, the first gate electrode is connected to the scan lines, the first source electrode is connected to the data lines, and the first drain electrode is connected to the first pixel electrode; and
wherein the sub-pixel portion comprises a second TFT and a second pixel electrode, the second TFT comprises a second gate electrode, a second source electrode, and a second drain electrode, the second gate electrode is connected to the scan lines, the second source electrode is connected to the data lines, and the second drain electrode is connected to the second pixel electrode.

16. The liquid crystal display panel as claimed in claim 15, wherein the sub-pixel portion further comprises a share TFT, wherein the share TFT comprises a third gate electrode, a third source electrode, and a third drain electrode, the third gate electrode is connected to the scan lines, the third source electrode is connected to the second drain electrode, and the third drain electrode is connected to a share electrode line of the pixel structure; and
wherein the share TFT is configured to adjust brightness of the sub-pixel portion so that brightness of the main pixel portion is the same as that of the sub-pixel portion.

17. The liquid crystal display panel as claimed in claim 16, wherein the share electrode line is disposed on the common electrode line, and materials of the share electrode line and the common electrode line comprise indium tin oxide or indium zinc oxide.

18. The liquid crystal display panel as claimed in claim 17, wherein widths of the share electrode line and the common electrode line are equal to or less than 10 μm.

19. The liquid crystal display panel as claimed in claim 14, wherein the color resist layer comprises red color resist blocks, green color resist blocks, and blue color resist blocks which are disposed at intervals, and a black matrix is disposed in gaps among the red color resist blocks, the green color resist blocks, and the blue color resist blocks.

20. The liquid crystal display panel as claimed in claim 10, wherein a common electrode layer is disposed on a surface of the color filter substrate, and the common electrode layer is disposed over the pixel areas.
